(19) United States
(12) Patent Application Publication
(10) Pub. No.: US 2004/0052530 A1
(43) Pub. Date: Mar. 18, 2004

(54) Optical network with distributed sub-band rejections

(76) Inventors: Cechan Tian, Plano, TX (US); Koji Takeguchi, Kawasaki (JP); Yasuhiko Aoki, Richardson, TX (US); Susumu Kinoshita, Plano, TX (US)

Correspondence Address: BAKER BOTTS L.L.P., 2001 ROSS AVENUE, SUITE 600, DALLAS, TX, 75201-2980, US

(21) Appl. No.: 10/246,053

(22) Filed: Sep. 17, 2002

(51) Int. Cl. H04B 10/20; H04J 14/00

(52) U.S. Cl. 398/83; 398/5; 398/59

(57) ABSTRACT

A node for an optical network includes a first transport element operable to be coupled to an optical ring and to transport traffic in a first direction and a second transport element operable to be coupled to the optical ring and to transport traffic in a second, disparate direction. The first and second transport elements each include an optical splitter element operable to split an ingress signal into an intermediate signal and a drop signal. A filter in each node is operable to reject a first sub-band of the network from the intermediate signal to generate a passthrough signal including a plurality of disparate sub-bands of the network. Each node further includes an add element operable to add local traffic in the first sub-band to the passthrough signal for transport in the network.

### TECHNICAL FIELD OF THE INVENTION

The present invention relates generally to optical transport systems, and more particularly to an optical network with distributed sub-band rejections.

### BACKGROUND OF THE INVENTION

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of transmitting the signals over long distances with very low loss.

Optical networks often employ wavelength division multiplexing (WDM) or dense wavelength division multiplexing (DWDM) to increase transmission capacity. In WDM and DWDM networks, a number of optical channels are carried in each fiber at disparate wavelengths. Network capacity is based on the number of wavelengths, or channels, in each fiber and the bandwidth, or size of the channels.

### SUMMARY OF THE INVENTION

A node for an optical network includes a first transport element operable to be coupled to an optical ring and to transport traffic in a first direction and a second transport element operable to be coupled to the optical ring and to transport traffic in a second, disparate direction. The first and second transport elements each include an optical splitter element operable to split an ingress signal into an intermediate signal and a drop signal. A filter in each node is operable to reject at least a first sub-band of the network from the intermediate signal to generate a passthrough signal including a plurality of disparate sub-bands of the network. Each node further includes an add element operable to add local traffic in at least the first sub-band to the passthrough signal for transport in the network.

Technical advantages of the present invention include includes providing an optical ring network with distributed sub-band rejections. In a particular embodiment, a disparate sub-band of the network is open at each node. As a result, an open ring network with flexible channel spacing within the sub-bands is provided. The network need not be physically opened at any one point and Unidirectional Path-Switched Ring (UPSR) protection switching is thus supported.

Other technical advantages of particular embodiments may include optical cross-connect capability with tunable band-pass filters. The provisioning of a simple, low-loss, and low-cost optical network may provide flexible channel spacing within sub-bands. Node configurations may allow for broadcasting of traffic, and negligible pass-band narrowing occurs within a sub-band. Ring-interference may be avoided, with low node loss (<4 dB) and low loss variations. Also, no channel power equalization may be necessary.

It will be understood that the various embodiments of the present invention may include some, all, or none of the enumerated technical advantages. In addition, other technical advantages of the present invention may be readily apparent to one skilled in the art from the following figures, description and claims.

### BRIEF DESCRIPTION OF THE DRAWINGS

For a more complete understanding of the present invention and its advantages, reference is now made to the following description taken in conjunction with the accompanying drawings, wherein like numerals represent like parts, in which:

FIG. 1 is a block diagram illustrating an optical ring network in accordance with one embodiment of the present invention;

FIG. 2 is a block diagram illustrating details of an add/drop node of FIG. 1 in accordance with one embodiment of the present invention;

FIG. 3A is a block diagram illustrating operation of the band pass filter of the node of FIG. 2 in accordance with one embodiment of the present invention;

FIG. 3B is a diagram illustrating the add, drop, and pass-through sub-bands of FIG. 3A in accordance with one embodiment of the present invention;

FIG. 4 is a block diagram illustrating exemplary travel paths of sub-bands of the network of FIG. 1 in accordance with one embodiment of the present invention;

FIG. 5 is a block diagram illustrating exemplary bandwidth travel paths on the optical ring of FIG. 1 and showing high-level details of the add/drop nodes in accordance with one embodiment of the present invention;

FIG. 6 is a block diagram illustrating protection of the travel paths of FIG. 5 in accordance with one embodiment of the present invention;

FIG. 7A is a block diagram illustrating details of an add/drop node in accordance with another embodiment of the present invention;

FIG. 7B is a block diagram illustrating details of an add/drop node in accordance with yet another embodiment of the present invention;

FIG. 8A is a block diagram illustrating exemplary travel paths of sub-bands on the network of FIG. 1 provisioned with the nodes of FIG. 7A or 7B in accordance with another embodiment of the present invention;

FIG. 8B is a block diagram illustrating redundancy features in an add drop note in accordance with yet another embodiment for the present invention;

FIG. 9 is a block diagram illustrating exemplary travel paths of sub-bands on the network of FIG. 1 in accordance with yet another embodiment of the present invention;

FIGS. 10A-C illustrate details and operation of an amplified spontaneous emission (ASE) filter in accordance with one embodiment of the present invention;

FIG. 11 is a flow diagram illustrating a method of managing traffic on an optical network accordance with one embodiment of the present invention; and

FIG. 12 is a flow diagram illustrating a method of inserting a new node into an optical network in accordance with one embodiment of the present invention.

### DETAILED DESCRIPTION OF THE INVENTION

FIG. 1 illustrates an optical network 10 in accordance with one embodiment of the present invention. In this embodiment, the network 10 is an optical ring network in which a number of optical channels are carried over a common path at disparate wavelengths. The network 10 may be a wavelength division multiplexing (WDM), dense wavelength division multiplexing (DWDM), or other suitable multi-channel network. The network 10 may be used in a short-haul metropolitan network, and long-haul inter-city network or any other suitable network or combination of networks.

As described in more detail below, network 10 is a ring network with sub-band rejections distributed around the ring. A sub-band, as used herein, means a portion of the bandwidth of the network comprising a subset of channels of the network. In particular embodiments, the entire bandwidth of a network may be divided into sub-bands of equal bandwidth, or, alternatively, of differing bandwidth. Sub-bands may be of In one embodiment, each node is assigned a sub-band in which to add its local traffic. The node also filters out or otherwise rejects ingress traffic in this band that has already circulated around the ring. Thus, each node controls interference of channels in the network 10 by both adding and removing traffic in its sub-band.

Referring to FIG. 1, the network 10 includes a plurality of nodes 12 and an optical ring 26 comprising a first optical fiber 14 and a second optical fiber 16. Optical information signals are transmitted in different directions on the fibers 14 and 16 to provide fault tolerance. Thus each node both transmits traffic to and receives traffic from each neighboring node. As used herein, the term “each” means every one of at least a subset of the identified items. It will be understood that optical ring 26 may comprise a two unidirectional optical fibers, as illustrated, or may comprise a single, bi-directional optical fiber. The optical signals have at least one characteristic modulated to encode audio, video, textual, real-time, non-real-time and/or other suitable data. Modulation may be based on phase shift keying (PSK), intensity modulation (IM) and other suitable methodologies.

In the illustrated embodiment, traffic in the first fiber 14 travels in a clockwise direction. Traffic in the second fiber 16 travels in a counterclockwise direction. The nodes 12 are operable to add and drop traffic to and from ring 26. At each node 12, traffic received from local clients is added to ring 26 while traffic destined for local clients is dropped. Traffic may be added to ring 26 by inserting the traffic channels or otherwise combining signals of the channels into a transport signal of which at least a portion is transmitted on one or both fibers 14 and 16. Traffic may be dropped from the ring 26 by making the traffic available for transmission to the local clients. Thus, traffic may be dropped and yet continue to circulate on a fiber 14 and/or 16.

In one embodiment, the nodes 12 are further operable to multiplex data from clients for adding to the ring 26 and to demultiplex channels of data from the ring 26. The nodes 12 may also perform optical-to-electrical or electrical-to-optical conversion of the signals received from and sent to the clients.

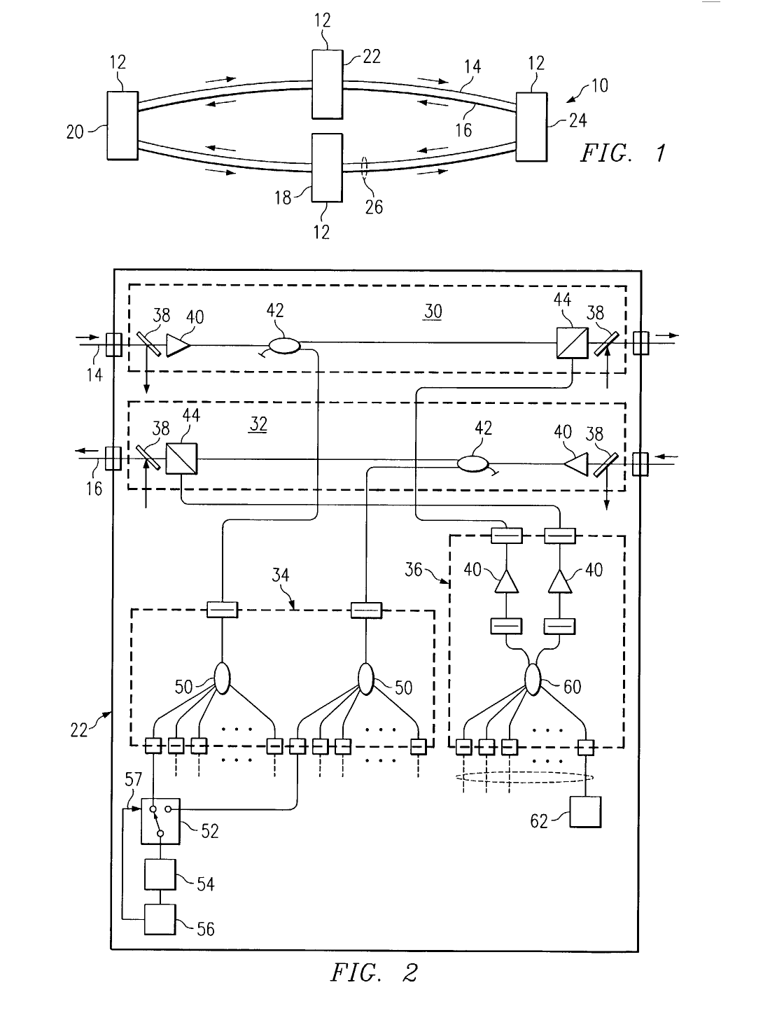

Signal information such as wavelengths, power and quality parameters may be monitored in the nodes 12 and/or by a centralized control system. Thus, the nodes 12 may provide for circuit protection in the event of a line cut in one or both of the fibers 14 and 16. In one embodiment, an optical supervisory channel (OSC) may be used by the nodes to communicate with each other and with the control system. In other embodiments, as described further below in reference to FIG. 2, network 10 may be a Unidirectional Path-Switched Ring (UPSR) network in which a switch is toggled so as to forward to a local client traffic from a direction (clockwise or counterclockwise) corresponding to the lower bit error rate (BER) and/or higher power level.

FIG. 2 illustrates details of the node 12 in accordance with one embodiment of the present invention. In the illustrated embodiment, at the node 12, traffic is passively dropped from ring 26 with a passive splitter. “Passive” in this context means without power, electricity, and/or moving parts. An active device would thus use power, electricity or moving parts to perform work. In a particular embodiment, traffic may be passively or otherwise dropped from ring 26 by splitting, which is without multiplexing/demultiplexing, in the transport rings and/or separating parts of a signal in the ring. A filter is operable to reject an assigned sub-band of the network, with the remaining sub-bands passing through. Local traffic may be added to ring 26 in the assigned sub-band. The traffic may be passively or otherwise added.

Referring to FIG. 2, the node 12 comprises a first, or counterclockwise transport element 30, a second, or clockwise transport element 32, a combining element 36 and a distributing element 34. The transport elements 30 and 32 add and drop traffic to and from the ring 26, remove previously transmitted traffic, and/or provide other interaction of the node 12 with the ring. The combining element 36 generates the local add signal passively or otherwise. The distributing element 34 distributes the drop signals into discrete signals for recovery of local drop traffic passively or otherwise. In a particular embodiment, the transport, combining and distributing elements 30, 32, 36 and 34 may each be implemented as a discrete card and interconnected through a backplane of a card shelf of the node 12. In addition, functionality of an element itself may be distributed across a plurality of discrete cards. In this way, the node 12 is modular, upgradeable, and provides a pay-as-you-grow architecture.

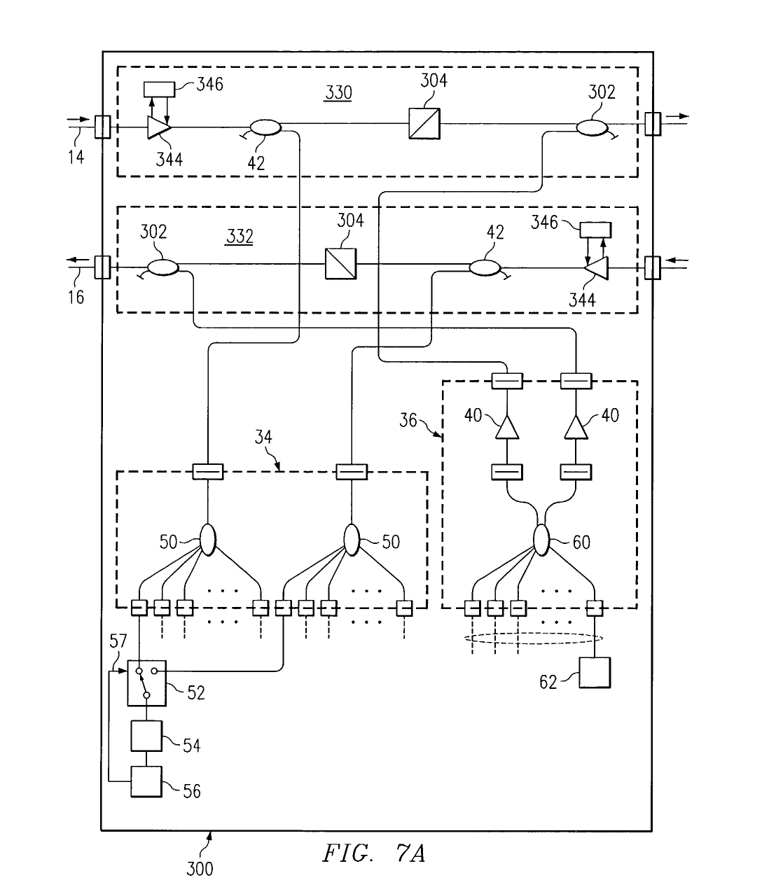

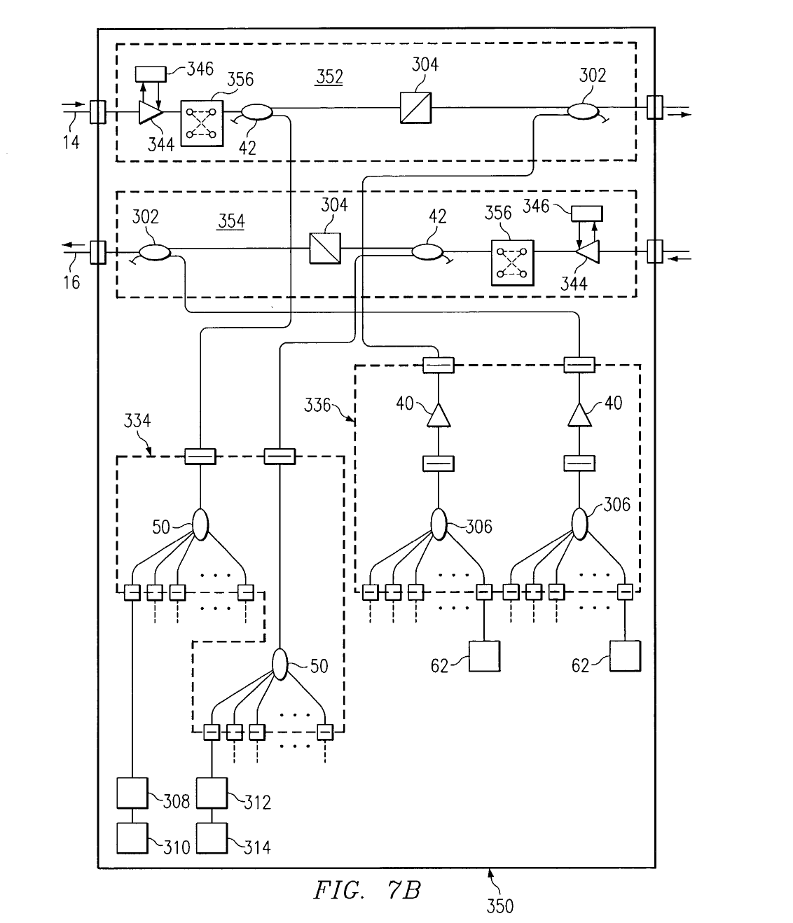

Each transport element 30 and 32 is connected or otherwise coupled to the corresponding fiber 14 or 16 to add and drop traffic to and from the ring 26. Each transport element 30 and 32 comprises an optical splitter element 42 operable to split an ingress signal into an intermediate signal and a drop signal, a filter 44 operable to reject an assigned sub-band of the network from the intermediate signal to generate a passthrough signal including a plurality of disparate sub-bands of the network, and an add element operable to add local traffic in the assigned sub-band to the passthrough signal for transport in the network. In the illustrated embodiment, filter 44 also acts as the add element. In other embodiments (for example, the embodiment illustrated in FIGS. 7A and 7B), the add element is a separate element. An add element may comprise a filter, coupler, or other suitable device for adding traffic to the optical network. Components may be coupled by direct, indirect or other suitable connection or association. In the illustrated embodiment, the elements of the node 12 and devices in the elements are connected with optical fiber connections, however, other embodiments may be implemented in part or otherwise with planar wave guide circuits and/or free space optics.

Optical splitter elements (“splitters”) 42 may each comprise an optical fiber coupler or other optical splitter operable to combine and/or split an optical signal. Splitters 42 provide flexible channel-spacing, herein meaning with no restrictions concerning channel-spacing in the main streamline. As used herein, an optical splitter or an optical coupler is any device operable to combine or otherwise generate a combined optical signal based on two or more optical signals without multiplexing and/or to split or divide an optical signal into discrete optical signals or otherwise passively discrete optical signals based on the optical signal without demultiplexing. The discrete signals may be similar or identical in frequency, form, and/or content. For example, the discrete signals may be identical in content and identical or substantially similar in power, may be identical in content and differ substantially in power, or may differ slightly or otherwise in content. In one embodiment, the splitter 42 may split the signal into two copies with substantially equal power. The coupler may have a directivity of over 55 dB. Wavelength dependence on the insertion loss may be less than about 0.5 dB over 100 nm. The insertion loss for a 50/50 coupler may be less than about 3.5 dB.

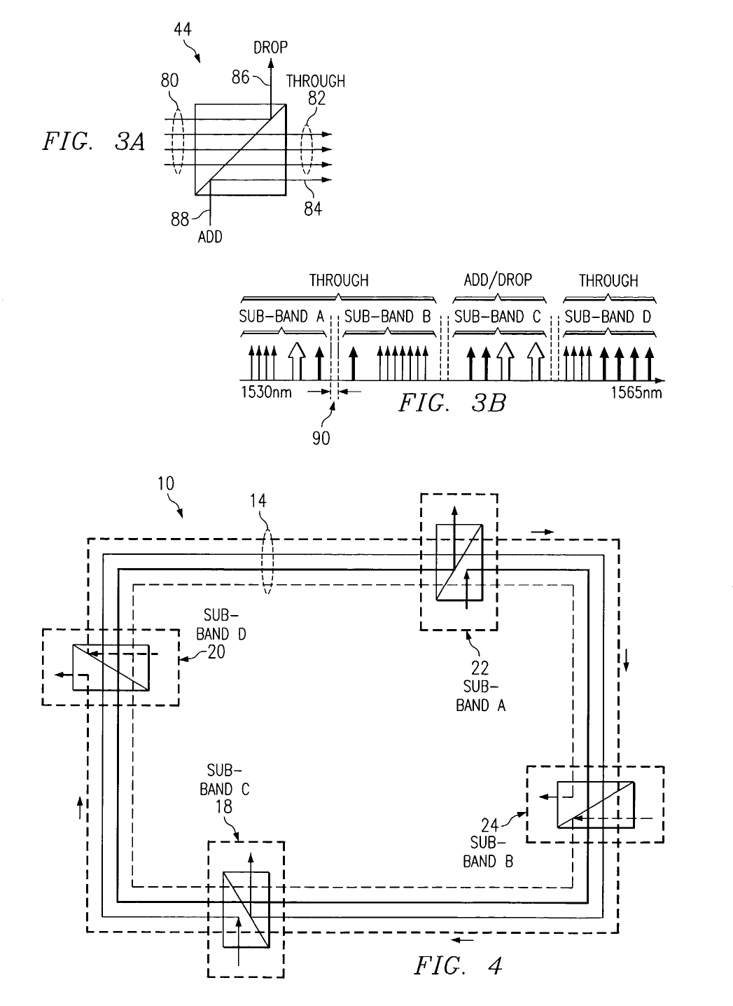

Filter 44, as described in further detail below in reference to FIGS. 3A and 3B, is operable to reject traffic in an assigned sub-band, and to pass the remaining traffic. Reject, as used herein, may mean terminate or otherwise remove from the traffic streamline. Filter 44 may also add local traffic in assigned sub-band. Filter 44 may be optically passive in that traffic multiplexing and/or demultiplexing is not required.

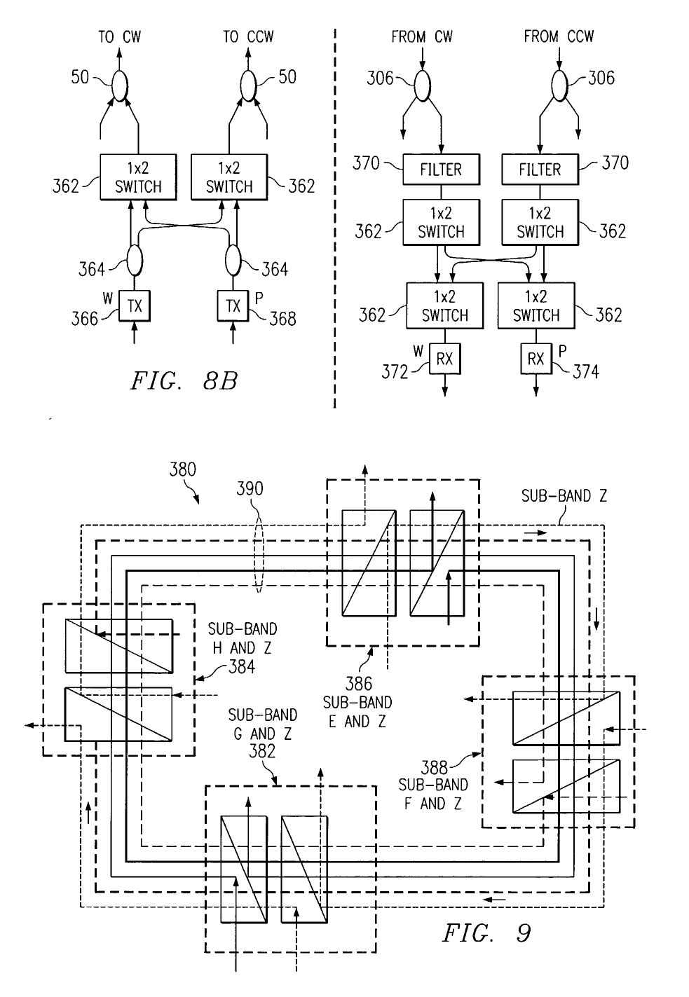

In one embodiment, the transport elements 30 and 32 each include an amplifier 40. Amplifiers 40 may be erbium-doped fiber amplifier (EDFAs) or other suitable amplifiers capable of receiving and amplifying an optical signal. The output of the amplifier may be, for example, 17 dBm. As the span loss of clockwise fiber 14 may differ from the span loss of counterclockwise fiber 16, amplifiers 40 may use an automatic level control (ALC) function with wide input dynamic-range. Hence amplifiers 40 may deploy automatic gain control (AGC) to realize gain-flatness against input power variation as well as variable optical attenuators (VOAs) to realize ALC function. In a particular embodiment, one or a plurality of nodes 12 in network 10 may include an amplified spontaneous emission (ASE) filter (not illustrated) coupled to amplifiers 40 to prevent the buildup of unwanted spontaneous emission or noise from the amplifiers of the network 10. ASE filters are described further below in reference to FIGS. 7 and 9.

In operation of the transport elements, amplifier 40 receives an ingress transport signal from the connected fiber 14 or 16 and amplifies the signal. The amplified signal is passed to optical coupler 42. Optical coupler 42 splits the amplified signal into an intermediate signal and a local drop signal from the fiber 14 or 16. Filter 44 rejects an assigned sub-band of the network from the intermediate signal to generate a passthrough signal, and adds local traffic in the assigned sub-band to the passthrough signal for transport on fibers 14 and 16. The local drop signal is passed to the distributing element 36 for processing. In this way, for example, traffic is passively dropped from the ring 26 in the node 12.

Distributing element 34 may comprise drop splitters 50 receiving dropped signals from fibers 14 or 16. Splitters 50 may comprise splitters with one optical fiber ingress lead and a plurality of optical fiber drop leads. The drop leads may be connected to a switch 52 which allows for UPSR protection switching and one or more filters 54 which in turn may be connected to one or more optical receivers 56.

In a particular embodiment, switch 52 is initially set-up so as to forward to the local client traffic from a direction (clockwise or counterclockwise) corresponding to a lower bit error rate (BER). A threshold value is established such that the switch remains in its initial set-up state as long as the BER does not exceed the threshold. Another threshold level may be established for power levels. If the BER exceeds the BER threshold or the power becomes less than the power threshold, the switch selects the other signal. Commands for switching may be transmitted via connection 57. This results in local control of and simple and fast protection.

The combining element 36 may comprise couplers 60 which receive traffic from a plurality of optical fiber add leads which may be connected to one or more add optical senders 62 associated with a local client or other source. Combining element 36 further comprises two optical fiber egress leads which feed into amplifiers 40. In other embodiments, amplifiers 40 may be omitted. Amplifiers 40 may comprise EDFAs or other suitable amplifiers. Thus, copies of the same traffic are forwarded to each of transport elements 30 and 32 via band-pass filters 44 to be added to ring 26 in both the clockwise and counterclockwise directions.

FIG. 3A is a block diagram illustrating operation of filter 44 of node 12 of FIG. 2 in accordance with one embodiment of the present invention. Filters 44 may comprise thin-film, fixed filters, tunable filters, or other suitable filters, and each filter 44 may comprise a single filter or a plurality of filters connected serially, in parallel, or otherwise. In the illustrated embodiment, filter 44 is a single band-pass filter.

As illustrated in FIG. 3A, band-pass filter 44 is operable to receive an optical signal 80 carrying traffic in a plurality of sub-bands. A sub-band is a portion of the bandwidth of the network. Each sub-band may carry none, one or a plurality of traffic channels. The traffic channels may be flexibly spaced within the sub-band. Band-pass filter 44 rejects an assigned sub-band 86 from the signal 80 and passes the remaining sub-bands 82 of the network. The rejected traffic is previously transmitted traffic which is removed to prevent re-circulation and channel interference. The passed traffic may be rejected at another node in the network 10. Local traffic in the assigned sub-band 86 may also be added to signal 80.

FIG. 3B is a diagram illustrating the sub-bands passed and added/dropped at filter 44 as illustrated in FIG. 3A in accordance with one embodiment of the present invention. As described above in reference to FIG. 3A, band-pass filter 44 may pass through selected sub-bands 82, and reject one or more selected sub-bands 86 from the signal 80. In the illustrated embodiment, the pass-through sub-bands 82 comprise sub-bands A and B, which comprise a plurality of channels in the lower end of the C-band spectrum. In the illustrated embodiment, sub-band A comprises four 2.5 Gb/s channels, one 10 Gb/s channel, and one 40 Gb/s channel (represented respectively by the small, medium, and large arrows), and sub-band B comprises one 10 Gb/s channel and seven 2.5 Gb/s channels. Pass-through sub-bands 82 also comprise sub-band D which is at the upper end of the C-band spectrum and comprises four 2.5 Gb/s channels and four 10 Gb/s channels. Rejected sub-band C comprises two 10 Gb/s channels and two 40 Gb/s channels in the same mid-range of the C-Band spectrum. Exemplary channel spacing is illustrated in FIG. 3B; however, channel spacing may be flexible, i.e., there is no restriction on the channel spacing, within the sub-bands. It will be understood that the bandwidth of the network may comprise other suitable bands, that the bandwidth may be otherwise subdivided into sub-bands of different sub-bandwidths, and that the rejected sub-bands may comprise different sub-bands than the added sub-bands.

In particular embodiments, some non-traffic carrying bandwidth is provided between adjacent sub-bands to avoid interference. In the illustrated embodiment, spacing 90 comprises a 200 GHz guard-band between adjacent sub-bands. Traffic signals are not allocated in the guard-bands so as to minimize signal loss and/or interference.

FIG. 4 is a block diagram illustrating exemplary bandwidth travel paths on the optical ring of FIG. 1 in accordance with one embodiment of the present invention. In the embodiment shown in FIG. 4, each of the nodes 12 rejects traffic from ring 26 from an assigned sub-band and adds new traffic to ring 26 in the assigned sub-band, with each node rejecting a different assigned sub-band. For ease of illustration, only fiber 14 of ring 26 is illustrated. It will be understood that the paths shown in FIG. 4 have corresponding paths in the counterclockwise direction on fiber 16.

Referring to FIG. 4, traffic is added at node 22 in sub-band A and travels the circumference of fiber 14 to be rejected from fiber 14 at node 22. In this way, channel interference is avoided. Likewise, sub-band B is rejected and added at node 24, sub-band C is rejected and added at node 18, and sub-band D is rejected and added at node 20. In a particular embodiment, sub-bands A, B, C, and D comprise sub-bands spanning the C-band spectrum, with each sub-band within the C-band is assigned to one of nodes 18, 20, 22, and 24.

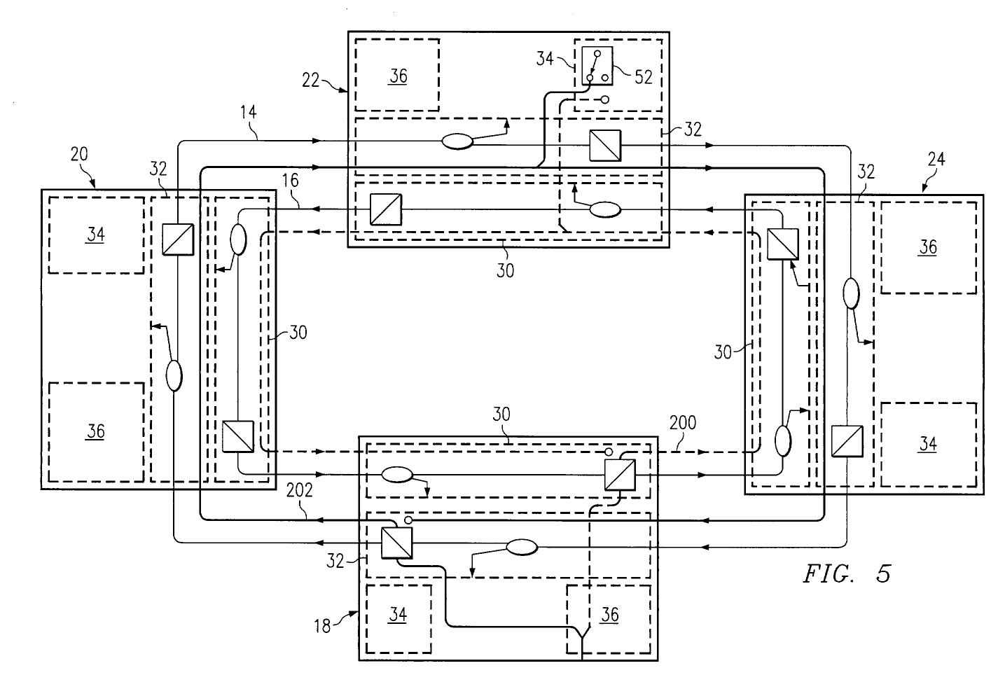

FIG. 5 is a block diagram illustrating exemplary bandwidth travel paths on the optical ring of FIG. 1 in accordance with one embodiment of the present invention. For ease of reference, only high-level details of the add/drop nodes 12 are shown.

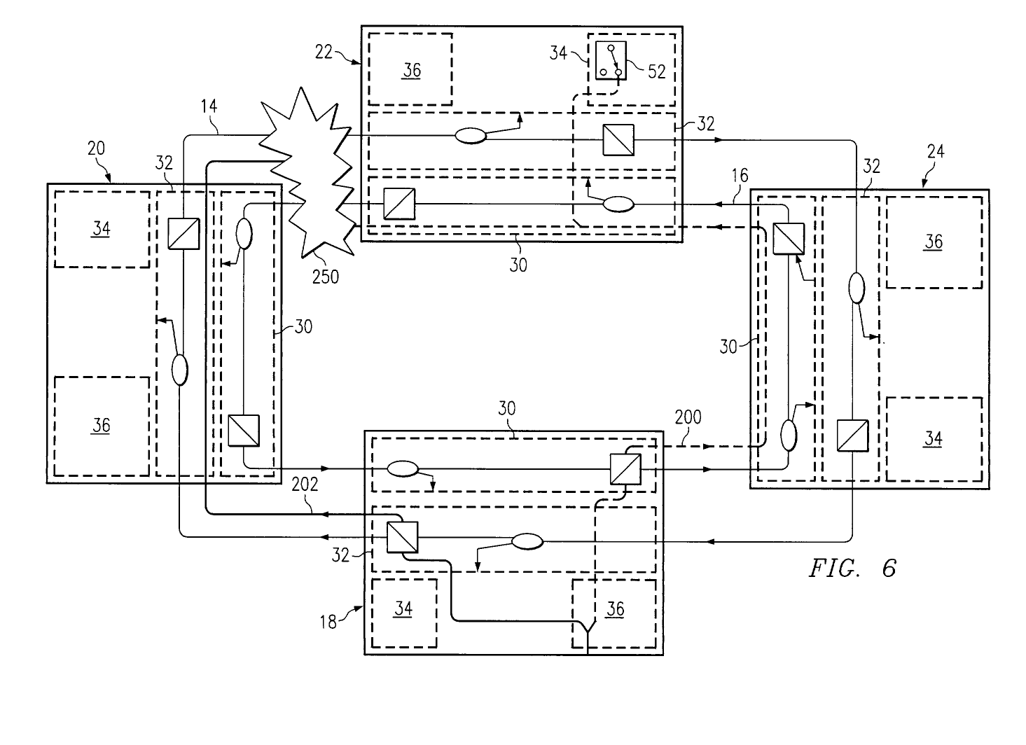

Referring to FIG. 5, lightpaths 200 and 202 represent a stream of the same traffic added to the network from an origination node 18 in a selected band (the “node 18 band”) in the counterclockwise and clockwise directions, respectively. In the illustrated embodiment, the intended destination node of the node 18 band is node 22. During normal operations, each of lightpaths 200 and 202 begin and are terminated at node 18, thus avoiding channel interference. As previously described, Each node adds and removes traffic in an assigned sub-band, and the lightpaths may be terminated by rejection by filter 44 which rejects all of the traffic in the assigned sub-band. It will be noted that, although FIG. 5 shows node 22 as the destination node, the node 18 band also reaches the drop ports of nodes 20, 24, and 18. Thus, the network has a broadcasting function. As described below in reference to FIG. 6, broadcasting of the node 18 band in both the clockwise and counterclockwise directions also provides protection in the event of a line cut or other interruption.

FIG. 6 is a block diagram illustrating protection of the travel paths of FIG. 5 during a line cut or other interruption in accordance with one embodiment of the present invention. In the example shown in FIG. 6, as described above, lightpaths 200 and 202 represent a stream of the same traffic added to the network from an origination node 18 in the counterclockwise and clockwise directions, respectively.

In the illustrated embodiment, line cut 250 prevents the node 18 band from reaching its destination node 22 via lightpath 202. Pursuant to the protection switching protocol, node 22 may, in response to sensing a BER exceeding the BER threshold for clockwise traffic, while still remaining below within the BER threshold for counterclockwise traffic due to the line cut, toggle switch 54 to switch from receiving clockwise (fiber 14) traffic to receiving counterclockwise (fiber 16) traffic. After repair of the line cut, the network may be reverted to its pre-protection switching state shown in FIG. 5 or, alternatively, may remain in the switched state.

FIG. 7A is a block diagram illustrating details of an add/drop node in accordance with another embodiment of the present invention. In particular embodiments, one or all of the elements shown in node 300 of FIG. 7A may be used in place of elements shown in nodes 12 of FIG. 2.

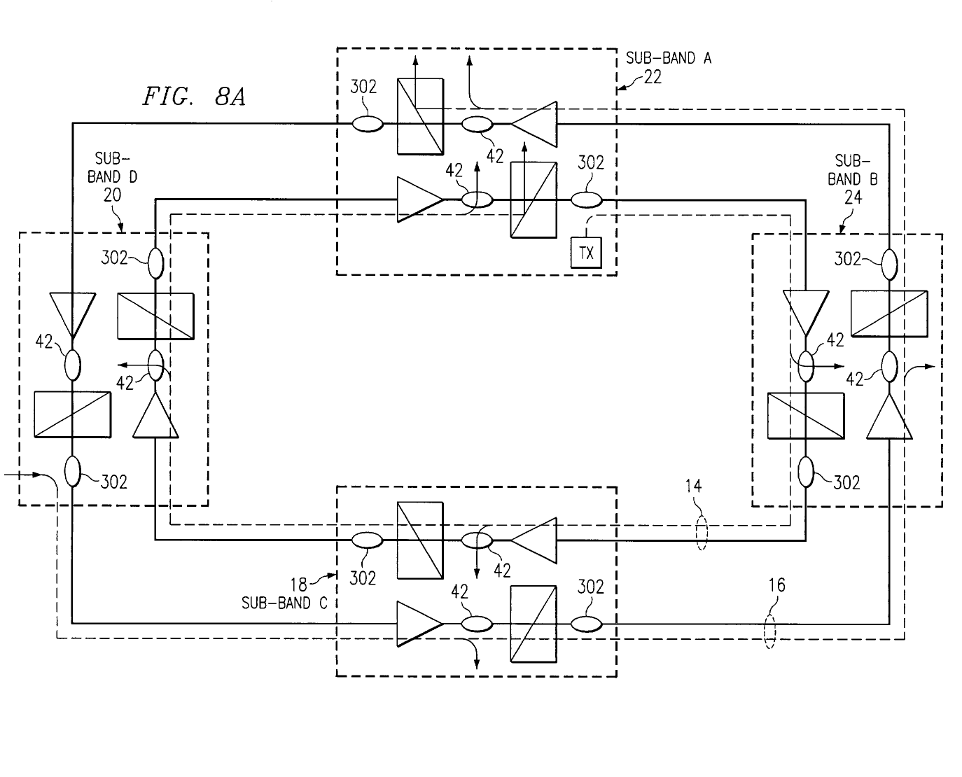

Node 300 comprises combining element 36 and distributing element 34, as described above in reference to FIG. 2. However, node 300 comprises, in place of transport elements 30 and 32, transport elements 330 and 332 which each comprise a filter 304 between drop coupler 42 and an add element comprising add coupler 302. Like drop coupler 42, add coupler 302 is passive and allows for flexible channel spacing. Filter 304 rejects one or more bands from the connected fibers 14 or 16, thus preventing channel interference. Filter 304 may comprise a tunable band-pass filter or another suitable filter. Filter 304, as described above in reference to filter 44, rejects traffic in an assigned sub-band; however, in the embodiment illustrated in FIG. 8, filter 304 may not add traffic to the network. Instead, local traffic is added via add coupler 302. The configuration of transport elements 330 and 332 allows for traffic outside the assigned sub-band to be added by add coupler 302 and thus, in a non-UPSR mode, for path sharing in the network, which increases overall network capacity, as described further below in reference to FIG. 8.

Amplifiers 344 may be erbium-doped fiber amplifier (EDFAs) or other suitable amplifiers capable of receiving and amplifying an optical signal. Node 300 also includes an amplified spontaneous emission (ASE) rejection filter 346 coupled to amplifiers 344 to prevent the buildup of unwanted spontaneous emission due to ASE circulation along the ring or noise from the amplifiers of the network 10. For example, a conventional EDFA has a gain bandwidth of 35 nm between 1530 nm and 1565 nm. The network may prevent the ASE circulation for any part of the entire gain bandwidth (1530-1565 nm) even if the node count in the ring is relatively small (for example, 3 nodes.) Therefore, in a particular embodiment, each ring has one ASE rejection filter 346 in at least one node on the ring. In a particular embodiment, ASE rejection filter 346s may be included in the transport elements of one node of a multiple-node network. In a particular embodiment, ASE rejection filter 346 may filter out or reject noise in unused sub-bands of the band of the network. As additional nodes are added to the network, additional sub-bands may be used for carrying traffic, and ASE rejection filter 346 may selectively reduce the sub-bands it filters so as to accommodate such additional sub-bands of traffic. As described below in reference to FIG. 9, ASE rejection filter 346 may comprise a multiple band-pass filter set to allow for expandability of the network as additional nodes are added.

FIG. 7B is a block diagram illustrating details of an add/drop node in accordance with yet another embodiment of the present invention. Add/drop mode 350 comprises distributing element 334 and combining element 336, and transport elements 352 and 354. Transport elements 352 and 354, like transport elements 330 and 332 of FIG. 7A, each comprise a filter 304 between drop coupler 42 and an add element comprising add coupler 302. 2×2 switches 356 are disposed between amplifiers 344 and drop couplers 42, and are operable to open the transport elements and thus the optical ring at node 350. In a particular embodiment, a 2×2 switch 356 may be opened in the event of a failure of an ASE rejection filter 346 such that the ASE rejection filter 346 cannot prevent ASE circulation for unused sub-bands. For example, if ASE rejection filter 346 in transport element 352 fails, 2×2 switches in transport element 352 and 354 are opened so as to effectively create a fibber cut in this segment. Under a UPSR protection regime, light paths would be protected under such an effective fiber cut situation.

Distributing element 334 may comprise drop splitters 50 receiving dropped signals from fibers 14 or 16. As with node 12, splitters 50 may comprise splitters with one optical fiber ingress lead and a plurality of optical fiber drop leads. However, one splitter 50 in node 300 is coupled to filter 308 which in turn is coupled to optical receivers 310, and one splitter is coupled to filter 312 which in turn is coupled to filter 314. Similarly, combining element 336 comprises coupler 316 coupled to sender 320 and coupler 318 coupled to sender 322. In this way, 1+1 protection and network redundancy is provided for in both the distributing and combining elements.

UPSR protection schemes may be supported through redundancy of receivers 62. In a particular embodiment, a receiver 62 may receive the same sub-band traffic from both the clockwise and counter-clockwise directions, thus allowing for simultaneous BER monitoring. In this embodiment, even if the BER of the working traffic slightly exceeds the BER threshold, the receiver corresponding to the lower BER may continue to receive traffic.

FIG. 8A is a block diagram illustrating exemplary bandwidth travel paths on an optical ring accordance with another embodiment of the present invention. In the embodiment shown in FIG. 8, path sharing allows for increased overall network capacity.

In FIG. 8A, nodes 18, 20, 22, and 24 comprise nodes 300 as described in reference to FIG. 7. As described above in reference to FIG. 4, sub-band B is rejected and any sub-band may be added at node 24, sub-band C is rejected and added at node 18, and sub-band D is rejected and added at node 20. However, for clarity, only the sub-band A lightpath is shown in FIG. 8.

Working traffic is added at node 22 in sub-band A in only the clockwise direction and travels the circumference of fiber 14 to be rejected from fiber 14 at node 22, as described above in reference to FIG. 4. However, the node configuration of FIG. 8 also allows for path sharing by allowing additional traffic in sub-band A to be added to fiber 16 at node 20. Such additional traffic may be referenced to as protection channel access (PCA) traffic. Both working and PCA sub-band A traffic is rejected at node 22 for both fibers 14 and 16, thus avoiding channel interference.

FIG. 8B is a block diagram illustrating transmitter and receiver redundancy features of an add drop note in accordance with another embodiment of the present invention. The transmitter redundancy elements shown in FIG. 8B may be added to the combining element 34 of FIGS. 2, 7A, or otherwise suitably employed in the present invention. Similarly, the receiver redundancy elements shown in FIG. 8B may be added to the distributor element 36 of FIGS. 2, 7A, or otherwise suitably employed in the present invention.

Redundant 1×2 switches 362 and redundant transmitters 366 and 368 provide for redundancy of traffic being added to the clockwise and counter-clockwise rings. Likewise, redundant filters 370, redundant receivers 372 and 374, and 1×2 switches 362 provide redundant avenues for receipt of traffic from the clockwise or counter-clockwise rings. In particular embodiments, redundancy may be provided for 1+1 protection or for N:1 protection.

FIG. 9 is a block diagram illustrating exemplary bandwidth travel paths on an optical ring in accordance with another embodiment of the present invention. Similar to the ring described in reference to FIGS. 1 and 4, network 380 comprises a plurality of nodes 382, 384, 386, and 388 in an optical ring comprising a clockwise optical fiber 390 and a counterclockwise optical fiber. The counterclockwise fiber is not shown for purposes of clarity. Similar to the embodiment shown in FIG. 4, each of the nodes 382, 384, 386, and 388 rejects traffic from the ring from an assigned sub-band and adds new traffic to the ring in the assigned sub-band with each node rejecting a different assigned sub-band. Traffic is added at sub-band 382 in sub-band G and travels the circumference of fiber 390 to be rejected from fiber 390 at node 382. Likewise, sub-band H is rejected and added at node 384, sub-band E is rejected and added at node 386, and sub-band F is rejected and added at node 388.

In contrast to the nodes described above, nodes 382, 384, 386, and 388 comprise an additional sub-band filter operable to reject and add an additional sub-band, sub-band Z. In the illustrated embodiment, sub-band Z is rejected and added at each of nodes 382, 384, 386, and 388. Thus, channels within common sub-band Z are added and dropped at each node. The dropped channels within sub-band Z can be reinserted into the ring or terminated at every node. If terminated, these drop channels in sub-band Z can be shared by different traffic in other nodes. In this way, the overall capacity of the network may be increased.

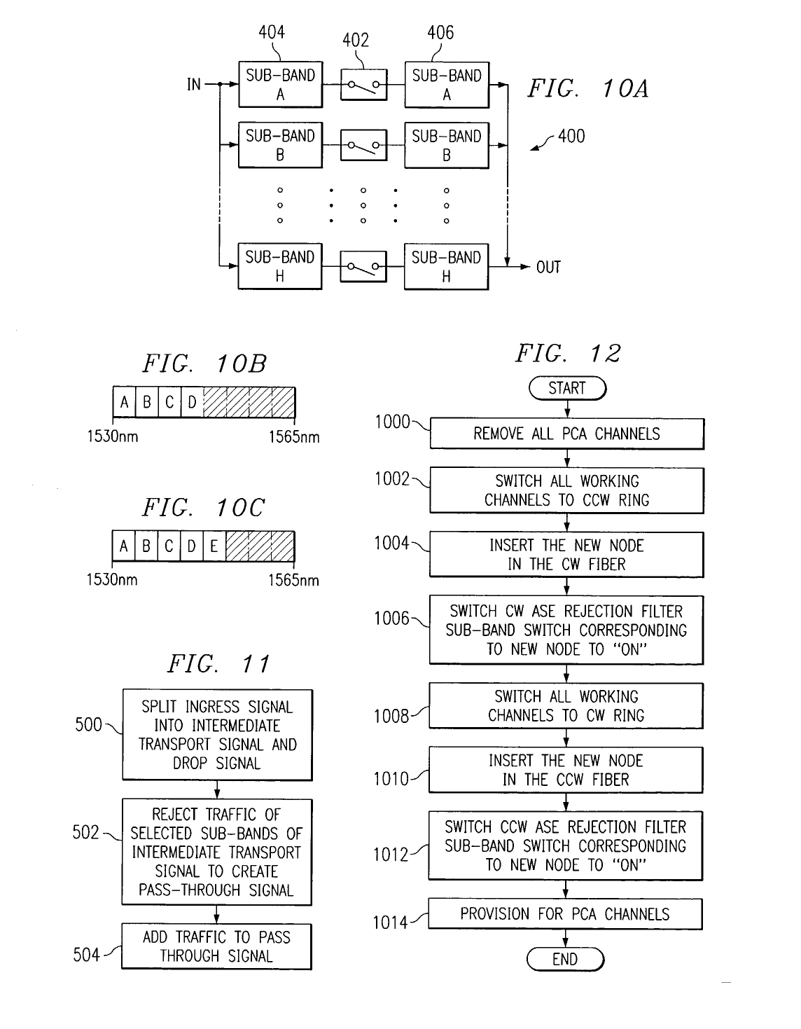

FIGS. 10A-C illustrate details and operation of an ASE rejection filter in accordance with one embodiment of the present invention. FIG. 10A is a block diagram illustrating a configurable ASE rejection filter 400 in accordance with one embodiment of the present invention. In a particular embodiment, ASE rejection filter 346 may comprise multiple filter set 400 to allow for expandability of the network as additional nodes and additional sub-bands are used for carrying traffic. It will be understood that ASE rejection filter 346 may in other embodiments comprise one or more filters connected serially, in parallel, or otherwise.

Filter set 400 may comprise a plurality of individual band-pass filters 404. Individual filters 404 and 406 may be provisioned to pass a selected sub-band, which may comprise one or more frequencies, and to reject other sub-bands. Switches 402 may be disposed so as to terminate traffic corresponding to particular filters 404 and 406. Filters 404 are operable to demultiplex the sub-bands, and filters 406 are operable to mulitplex the sub-bands in the illustrated embodiment band pass filters 404 and 406 correspond to sub-bands A-H.

In the cascaded filter set 400, both transmission and reflection of each sub-band are utilized. For example, if the input of ASE consists of all sub-bands (A, B, . . . H), sub-bands B through H are filtered at the filter 404 corresponding to sub-band A, and sub-band A is passed through. In a particular embodiment, the spectral power (mW/Hz) of the sub-band A light in the reflected light is 1/10000 of the spectral power of the passed-through sub-bands (B, C, D, . . . H), and the spectral power of the rejected sub-bands (B, C, D, . . . H) in the transmitted light is 1/100 of the spectral power of sub-band A. When switch 202 corresponding to sub-band A is in the “on” or “through” position, the spectral power of rejected sub-bands (B, C, D, . . . H) is 1/10000 of the spectral power of the passed through sub-band A.

The reflected sub-bands (B, C, D, . . . H) from sub-band A filter 404 enter the filter 404 corresponding to sub-band B. Then reflected sub-bands at the sub-band B filter 404 contain only sub-band C, D, E, F, G, and H. At the last filter 404, sub-band H light enters sub-band filter H 404 and passes through sub-band filter H 406. As power-loss at reflection is quite small, loss of each sub-band is substantially the same, resulting from loss from the two sub-band filters (404 and 406) and from switch 402. Therefore, wavelength (or sub-band) dependent loss of multiplexed light at the output is small.

Second filters 406 are provisioned to further filter the passed-through light. For example, sub-band B light (if the corresponding switch 202 is on; “through”) passes sub-band B filter 406 and then is mixed with the passed-through and reflected sub-band A light, thereby multiplexing sub-bands A and B. As described above, by controlling switches 202, ASE rejection filter varies its bandwidth on sub-band basis.

As additional nodes and/or sub-bands are added to the network, additional switches 402 may be closed to allow additional sub-bands to pass. For example, as shown in FIG. 10B, a four-node network may carry four sub-bands A, B, C and D. The filter set 400 may be provisioned to reject all but sub-bands A, B, C and D, thus reducing or eliminating noise in the other, unused sub-bands. As an additional sub-band E is added, as illustrated in FIG. 10C, additional switches 402 corresponding to the additional sub-bands may be closed, thus allowing the additional band-pass filters 404 and 406 corresponding to the additional nodes to pass traffic corresponding to those bands.

FIG. 11 is a flow diagram illustrating a method of transporting traffic on an optical network accordance with one embodiment of the present invention. As described above, traffic is transported in an optical ring network, with each node assigned a sub-band of the network to add channels. The sub-bands may include any suitable number of traffic channels. The traffic may be transported in a first direction and a second direction on the optical ring.

Beginning with step 500, at each node coupled to the ring, a transport signal comprising ingress traffic is passively split into a drop signal and an intermediate signal. At step 502, a band-pass or other suitable filter rejects one or more sub-bands of channels from the intermediate signal to create a passthrough signal.

Proceeding to step 504, traffic is added to the passthrough signal. The traffic may be added in sub-bands via the band-pass filter, or may be added via an optical coupler.

FIG. 12 is a flow diagram illustrating a method of inserting an additional node into an optical network in accordance with one embodiment of the present invention. The method of FIG. 12 may be utilized in an embodiment such as that shown in the FIG. 8 wherein path sharing is utilized for protection channel access (PCA) traffic.

Beginning with step 1000, PCA traffic is removed from the network by ceasing PCA traffic transmission or otherwise. Proceeding to step 1002, all working channels are switched to the counter-clockwise ring. At step 1004, the clockwise fiber is disconnected where the new node is to be inserted, and the new node is inserted into the network and connected to the clockwise fiber. Proceeding to step 1006, the clockwise ASE rejection filter corresponding to the new node is switched to the “on” or through position.

Proceeding to step 1008, all working channels are switched to the clockwise direction. At step 1010, the counter clockwise fiber is disconnected where the new node is to be inserted, and the new node is connected to the counter-clockwise fiber. At step 1012, the counter-clockwise ASE rejection filter corresponding to the new node is switched to the on position. Finally, at step 1014, the network is provisioned as shown in FIG. 8 or otherwise suitably provisioned for path sharing such that PCA traffic may be transmitted on the network.

In an embodiment of the present invention wherein UPSR protection switching is utilized, the method of FIG. 12 would not be utilized. Instead, insertion of a new node would involve disconnecting the optical ring at the point on the ring where the new node is to be inserted, and connecting the new node to the clockwise and counter-clockwise optical fibers. The switches 52 will automatically protect any traffic interrupted by the temporary opening of the ring by switching to the signal corresponding to the lowest BER. ASE rejection filter 344 may be provisioned to allow transmittal of the new sub-band corresponding to the new node, by, in a particular embodiment, switching the sub-band filter corresponding to the new node to the on position, as described above in reference to FIGS. 10A-10C.

Although the present invention has been described with several embodiments, various changes and modifications may be suggested to one skilled in the art. It is intended that the present invention encompass such changes and modifications as fall within the scope of the appended claims.

What is claimed is:

1. A node for an optical network, comprising:
a first transport element operable to be coupled to an optical ring and to transport traffic in a first direction;
a second transport element operable to be coupled to the optical ring and to transport traffic in a second, disparate direction; and
the first and second transport elements each comprising:
an optical splitter element operable to split an ingress signal into an intermediate signal and a drop signal;
a filter operable to reject at least a first sub-band of the network from the intermediate signal to generate a passthrough signal including a plurality of disparate sub-bands of the network; and
an add element operable to add local traffic in at least the first sub-band to the passthrough signal for transport in the network.

2. The node of claim 1, wherein each filter also comprises the add element.

3. The node of claim 1, wherein the add elements each comprise an optical coupler operable to passively add the local traffic in the first sub-band to the pass-through signal.

4. The node of claim 1, wherein each sub-band includes a plurality of traffic channels.

5. The node of claim 1, further comprising:
an amplifier; and
an amplified spontaneous emission (ASE) filter coupled to the optical ring and operable to selectively filter out energy from sub-bands not used for carrying traffic within the network.

6. The node of claim 1, wherein the node comprises a switch operable to forward to a receiver dropped traffic selectively from the first direction or the second direction.

7. The node of claim 1, wherein the filter comprises a tunable filter operable to selectively reject sub-bands of the network.

8. An optical network, comprising:
an optical ring; and
a plurality of nodes, each node comprising:
a first transport element operable to be coupled to an optical ring and to transport traffic in a first direction;
a second transport element operable to be coupled to the optical ring and to transport traffic in a second, disparate direction; and
the first and second transport elements each comprising:
an optical splitter element operable to split an ingress signal into an intermediate signal and a drop signal;
a filter operable to reject at least a first sub-band of the network from the intermediate signal to generate a passthrough signal including a plurality of disparate sub-bands of the network; and
an add element operable to add local traffic in at least the first sub-band to the passthrough signal for transport in the network.

9. The optical network of claim 8, wherein each filter also comprises the add element.

10. The optical network of claim 8, wherein the add elements each comprise an optical coupler operable to passively add the local traffic in the first sub-band to the pass-through signal.

11. The optical network of claim 8, wherein each sub-band includes a plurality of traffic channels.

12. The optical network of claim 8, wherein at least one node comprises:
an amplifier; and
an amplified spontaneous emission (ASE) filter coupled to the optical ring and operable to filter out energy from sub-bands not used for carrying traffic within the network.

13. The optical network of claim 8, wherein each node comprises a switch operable to forward to a receiver dropped traffic selectively from the first direction or the second direction.

14. The optical network of claim 8, wherein the filter comprises a tunable filter operable to selectively reject sub-bands of the network.

15. A method of transporting traffic on an optical ring, comprising:
at one or more nodes coupled to the optical ring, splitting an ingress signal into an intermediate signal and a drop signal;
rejecting from the intermediate signal traffic in at least a first sub-band of the network assigned to the node to generate a passthrough signal including sub-bands assigned to the other nodes;
adding local traffic in the sub-band assigned to the node to the passthrough signal for transport in the optical ring.

16. The method of claim 15, wherein the rejecting is via a filter.

17. The method of claim 15, wherein the adding is via the filter.

18. The method of claim 15, wherein the adding is via a coupler element.

19. The method of claim 15, further comprising:
transporting the traffic on the ring in a first direction and in a second, disparate direction, and;
forwarding to a receiver dropped traffic selectively from the first direction or the second direction.
